(19) United States
(12) Patent Application Publication
(10) Pub. No.: US 2003/0115458 A1
(43) Pub. Date: Jun. 19, 2003

(54) Invisable file technology for recovering or protecting a computer file system

(76) Inventor: Dongho Song, San Jose, CA (US)

Correspondence Address: Janaki Komanduri, c/o SKJERVEN MORRILL MacPHERSON LLP, Suite 700, 25 Metro Drive, San Jose, CA, 95110, US

(21) Appl. No.: 10/028,046

(22) Filed: Dec. 19, 2001

(51) Int. Cl. H04L 9/00

(52) U.S. Cl. 713/165; 713/200

(57) ABSTRACT

Invisible file technology is used for protection and recovery of a file system. In particular, a selection of one or more items to be included in a safety zone is received. A system call that may affect an item in the safety zone is intercepted. If the system call affects an item in the safety zone, the system call is processed to avoid permanent modification of the item. In particular, the invisible file technology provides data protection by altogether preventing certain modifications to the file system and, in some cases, provides recovery for a file system of a computer by returning the file system to its original form when there are unwanted modifications.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD OF THE INVENTION

The present invention relates generally to the field of data protection, and, more particularly, to using invisible file technology for recovering or protecting a computer file system.

### BACKGROUND

Computers are becoming increasingly popular for both business and personal use. Unfortunately, the data stored in computers may be intentionally damaged by people without authorized access (e.g., hackers) or unintentionally damaged by authorized users during normal usage of the computer (e.g., system administrators). This damage can be any undesirable addition, deletion, update, or renaming or other modification of disk drives, directories, and/or files. When the disk drives, directories, and/or files of a computer's file system are damaged, a system administrator is typically required to manually reconfigure the computer to correct the damage, for example, by reloading files that were deleted.

This type of damage often occurs in a classroom setting. With the growing popularity of computers, more students are taking computer classes to learn how to use computers. Typically, a student plays with a computer's file system to learn how to create, delete, rename, and edit files. In some cases, the student may damage files that are especially relevant or important to a computer's operation. For example, a student may intentionally or unintentionally delete a system file that is required for the computer to interact with other devices. This requires that a teacher or system administrator review each computer after a student has used the computer and return the computer's file system to its original configuration (i.e., the configuration the file system was in prior to the student's use). Such process by which a teacher or system administrator re-configures computers can be tedious and time-consuming, especially, for example, in a setting where many computers are used for teaching. In addition, the performance of each computer may be reduced during this process. A further problem is that hard disk lifetime is shortened. In particular, recovery data may be stored on a hard disk of a computer when existing “Mirror Systems” technology is used, and frequent access of the hard disk for recovery may shorten the hard disk's lifetime.

### SUMMARY

The disadvantages and problems associated with previous techniques for handling damaged file systems have been substantially reduced or eliminated with embodiments of the present invention using invisible file technology.

According to an embodiment of the present invention, a system for protecting a file system of a computer is provided. The system includes an interface operable to receive a selection of an item of the file system to be included in a safety zone. Additionally, the system includes a memory in communication with the interface and operable to store information relating to the item. Also, the system includes a processor in communication with the memory and operable to intercept a system call which potentially could affect the item in the safety zone, and to process the system call to avoid permanent modification of the item.

According to another embodiment of the invention, a method of protecting and recovering a file system in a computer is provided. File system information obtained from examining an operating system and a file system structure in the computer is stored. A safety zone is set based on selection of a target that is to be protected or recovered, wherein selection is made in response to input by an authenticated administrator. A system call referencing a file pathname corresponding to the target is received. The system call is analyzed to determine if the system call affects the target. If the system call may affect the target, performing processing to avoid permanent modification of the target.

According to yet another embodiment of the present invention, a method of protecting and recovering a file system is provided. A selection of an item to be included in a safety zone is received. A system call received is intercepted which potentially could affect the item in the safety zone and processing is performed responsive to the system call so that the item is not permanently modified.

According to a further embodiment of the invention, a method of protecting and recovering a file system of a computer is provided. A selection of an item to be included in a safety zone is received from an administrator. A system call received from a user is intercepted which potentially could affect the item in the safety zone and processing is performed responsive to the system call so that the item is not permanently modified.

According to yet another embodiment of the invention, a computer-readable storage medium stores a computer program executable by one or more computers. The computer program comprising computer instructions for receiving a selection of an item to be included in a safety zone; intercepting a system call which potentially could affect the item in the safety zone; and, performing processing responsive to the system call so that the item is not permanently modified.

Other aspects and advantages of the present invention will become apparent from the following descriptions and accompanying drawings.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates a client/server architecture, according to an embodiment of the present invention;

FIG. 2 illustrates a recovery and protection system architecture according to an embodiment of the present invention;

FIG. 3 illustrates an interaction of the recovery and protection system with other computer elements according to an embodiment of the present invention;

FIG. 4A illustrates a window for a user interface that may be presented on a server computer according to an embodiment of the present invention, and FIG. 4B illustrates an icon menu bar of a server version of the user interface according to an embodiment of the present invention;

FIGS. 5A and 5B illustrate windows for user interfaces that may be presented to an administrator for setting safety and open zones according to an embodiment of the present invention;

FIG. 6A illustrates a window for a user interface that may be presented on a client computer according to an embodiment of the present invention, and FIG. 6B illustrates an icon menu bar of a client version of the user interface according to an embodiment of the present invention;

FIGS. 7A-7C illustrate a flowchart of a method for recovery and protection of files, directories, drives, registers, and the like, according to an embodiment of the present invention;

FIG. 8 illustrates a flow chart of a method for performing system analysis, according to an embodiment of the present invention;

FIG. 9 illustrates a flow chart of a method for processing a reboot command, according to an embodiment of the present invention;

FIG. 10 illustrates a flow chart of a method for processing a request for administrator authorization, according to an embodiment of the present invention;

FIG. 11 illustrates a flow chart of a method for processing an administrator command, according to an embodiment of the present invention;

FIG. 12 illustrates a flow chart of a method for processing a general user command, according to an embodiment of the present invention

FIGS. 13A and 13B illustrate a flow chart of a method for performing recovery pre-processing, according to an embodiment of the present invention;

FIG. 14 illustrates a flow chart of a method for performing recovery main processing, according to an embodiment of the present invention; and

FIGS. 15A-15C illustrate a flow chart of a method for performing recovery post-processing, according to an embodiment of the present invention;

Use of the same reference symbols in different figures indicates similar or identical items.

### DETAILED DESCRIPTION

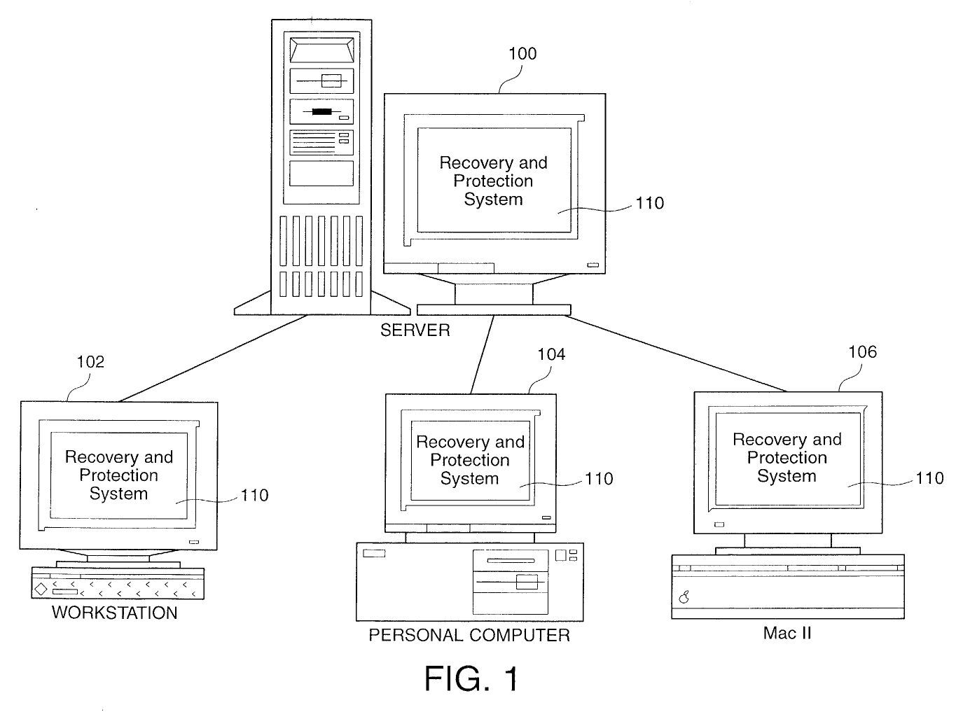

The preferred embodiments for the present invention and their advantages are best understood by referring to FIGS. 1-15 of the drawings. Like numerals are used for like and corresponding parts of the various drawings.

In one embodiment, the present invention provides invisible file technology for recovery and protection. In particular, an embodiment of the present invention provides data protection by altogether preventing certain modifications to the file system and, in some cases, provides recovery for a file system of a computer by returning the file system to its original form when there are unwanted modifications.

FIG. 1 illustrates a client/server architecture, according to an embodiment of the present invention. In this embodiment, a recovery and protection system 110 may be implemented in server computer 100 and/or one or more client computers 102, 104, and 106 (also referred to as “clients”). The recovery and protection system 110 may be used by, for example, a system administrator to set up safety zones or open zones for the file system on any one, up to all, of computers 100, 102, 104, and 106. A safety zone can comprise a portion of a computer's file system that are protected from modification or recovered after modification. An open zone can comprise portions of a computer's file system that are not protected from modification and that are not recovered after modification. Both the safety zone and the open zone may be as small as a file or as large as the entire logical drive. All of the contents in a safety zone, on which a user performed various modifications, are restored to their original form upon rebooting of the computer. However, in the open zone, the contents on which a user performed modifications remain modified upon rebooting of the computer. The recovery and protection system 110 may be implemented using software, hardware, or a combination of software and hardware. In one embodiment, the recovery and protection system 110 residing on server computer 100 may comprise software specific for a server, while the recovery and protection system 110 residing on client computers 102, 104, and 106 may comprise software specific for clients. The software/hardware implementing the recovery and protection system 110 in the server and clients may have the same or different functionality.

In one embodiment, an administrator or other individual, computer, or device may select targets to be included in a safety zone. A target may be, for example, one or more entire file systems, one or more drives of a computer system, one or more directories of the file system, one or more files of the file system, and/or one or more registries (e.g., storage areas for storing information on computer memory, system options, and attached hardware devices for Windows® 98, Windows® NT, and Windows® 2000 or any other suitable operating systems).

If a user damages one or more targets in the safety zone intentionally or accidentally, the one or more targets may appear damaged to the user, but the original information associated with the targets remains undamaged. For example, when a user attempts to delete a file in a safety zone for a computer, the recovery and protection system 110 modifies the directory of the computer so that it appears to the user that this file has been deleted, but the file has actually been stored for recovery.

Thus, in one embodiment, the recovery and protection system 110 preserves the original structure of the file system, drives, directories, files, and/or registry for one or more computers, although these may appear to be damaged by users. Additionally, the recovery and protection system 110 can prevent a lowering of efficiency from computer malfunction by protecting against damaged resources and facilitating recovery.

In one embodiment, the recovery and protection system 110 implements a technique for recovering and protecting computer file systems from intentional and accidental damage by users (whether authorized or unauthorized) using “invisible file technology.” With invisible file technology, when a user submits a command to modify the file system, the recovery and protection system 110 intercepts and processes the command. For some commands, the recovery and protection system 110 controls what is presented to a user so that it appears to the user that the command was executed (thus leading a user to believe that files have been modified or changed), but in reality, no such change or modification to the files has occurred. Therefore, users may think that they have created, written and/or deleted files through a user interface, but the file system remains essentially unchanged. That is, the recovery and protection system 110 is operable to make an item of the file system (which may be the entire file system) transparent to a user of the computer.

In particular, in one embodiment, once an administrator has set safety and open zones at a computer, when a user is using the computer, the recovery and protection system 110 intercepts commands from the user and determines whether to forward or pass these on to the operating system of the computer for processing or execution. When a command involves modification of data that is protected in the safety zone of the computer, the recovery and protection system 110 may not route or forward the command on to the operating system. Instead, the recovery and protection system 110 may adjust or control the user interface so that it appears to the user that the requested command was performed by the operating system.

For example, with a graphical user interface, if recovery and protection system 110 intercepts a command to delete an essential system file (e.g., BIOS), recovery and protection system 110 adjusts the interface so that the system file no longer appears on a directory displayed on the graphic al user interface. However, such system file still exists within the computer. Thus, the recovery and protection system 110 may preserve the original structure of the file system without modification, although the file system appears to a user as if it had been modified. In this manner, the recovery and protection system 110 may protect against users corrupting data intentionally or unintentionally (i.e., accidentally).

For any computer, the recovery and protection system 110 may perform inspection and analysis of the computer's operating system and file system and store information on the same. The recovery and protection system 110 may also allow an administrator to set safety and open zones to identify one or more targets to be protected and recovered.

In one embodiment, once the administrator has set safety zones in the computers, the recovery and protection system 110 may perform string conversion of the targets in each safety zone so that targets are “invisible” to users. The recovery and protection system 110 may store the converted strings of the targets in the safety zone. The recovery and protection system 110 may also perform an analysis of any user requests that include file pathnames and/or system calls that affect one or more targets within safety zones of the file systems. The recovery and protection system 110 may mark any target to be modified to indicate the type of modification and may create a copy of the unmodified target for use in recovering the file system.

Moreover, the recovery and protection system 110 may make the targets transparent to users (i.e., users are unable to view the targets in the file system). Thus, although the targets exist, they are not readily available for modification by a user. Furthermore, the recovery and protection system 110 may prevent a modified target, such as, for example, a target that has been modified for protection or recovery by the recovery and protection system 110, from being accessed by users and applications. In some embodiments, the recovery and protection system 110 may allow a user or application to modify a target, but thereafter, replace the target with a new, unmodified copy.

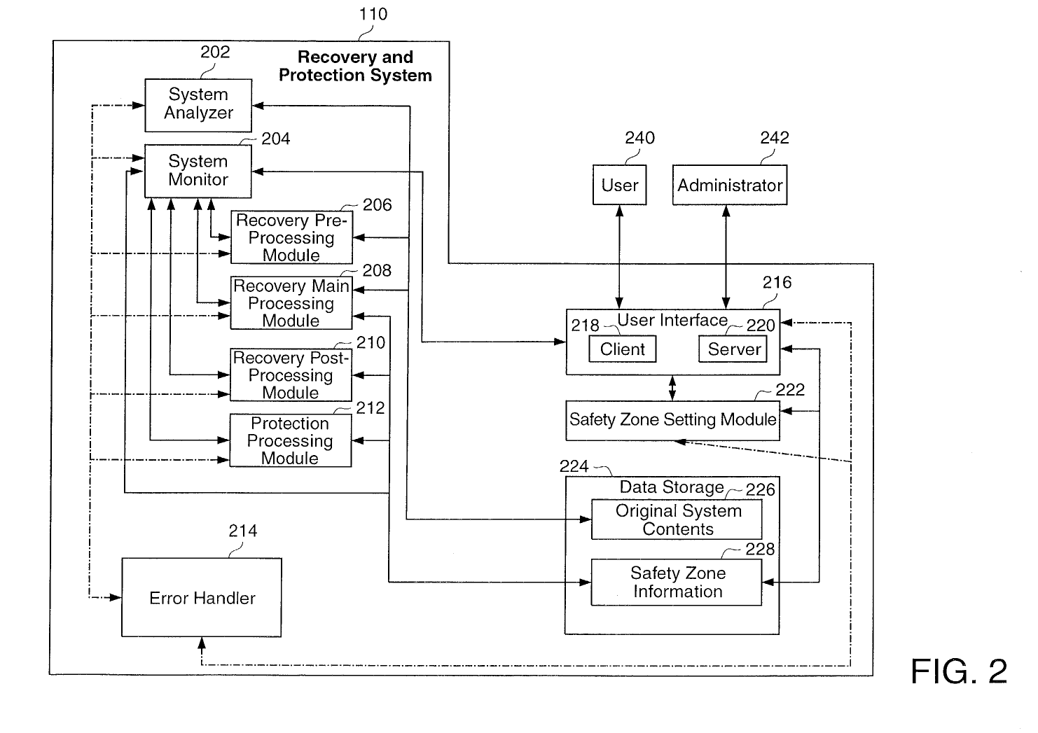

FIG. 2 illustrates a recovery and protection system 110 architecture according to an embodiment of the present invention. A user 240 or an administrator 242 may interact with the recovery and protection system 110 via a user interface 216. The user interface 216 may be used, for example, to display, select, and update a target within a safety zone. In one embodiment, the user interface 216 may include a client version 218 and a server version 220. Although both the client version 218 and server version 220 are illustrated within one user interface 216, the client and server versions may be separate user interfaces that are implemented or stored on a client computer 102, 104, or 106 and server computer 100, respectively. The functionality of user interface 126 may be provided, implemented, or supported with one or more suitable input devices (e.g., keyboard, keypad, mouse, touch pad, joystick, microphone, touch screen, etc.) and one or more suitable output devices (e.g., monitor, speaker, LED, etc.).

An administrator 242 may access the client version 218 on a client computer or the server version 220 on a server computer to set one or more safety zones. A safety zone may include all or a portion of a file system or drive or one or more directories or files or registries, or some combination of these. When an item is selected to be within a safety zone, the recovery and protection system 110 may “shield” the item from permanent modifications.

Initially, a system analyzer 202 may actively examine the operating system and the file system structure of a computer and store the results in data storage 224 as original system contents 226. The functionality of data storage 226 may be provided, implemented, or supported with one or a combination of suitable storage devices for storing data, such as, for example, cache memory, disk memory, random access memory (RAM), etc. Usually, the original structure of the computer file system, including its composition (e.g., elements that are included in the file system), information structure (e.g., how elements of the file system are arranged relative to each other), and “normal” status (e.g., default status of the file structure when a system administrator sets up a computer for use by, for example, a student), are examined. In one embodiment, the system analyzer 202 may prevent the computer from being booted up with a floppy disk or CD-ROM (Compact Disc—Read Only Memory) drive (sometimes referred to as “abnormal” booting media), to avoid damage to the computer system.

The safety zone setting module 222 processes the safety zones. In particular, the safety zone setting processing module 222 may convert the names of file systems, drives, directories, files, registries and the like, which desirably should not be damaged, into strings for storage in the data storage 224 as safety zone information 228. For example, when drive C: is selected as a target to be recovered or protected, its name is stored as C:\ in the safety zone information 228. Likewise, when an administrator (or other user) selects the Windows directory in drive C: as a safety zone, its name as C:\WINDOWS\SYSTEM is stored in the safety zone information 228, but file “system.ini” in the system files will be displayed as C:\WINDOWS\SYSTEM\SYSTEM.INI to a user. As another example, if an administrator selects “C:\MYDOCUMENTS\AAA.TXT” as a safety zone, the safety zone information 228 will include “C:\MYDOCUMENTS\AAA.TXT.”

In one embodiment, a system monitor 204 may analyze the file pathnames and system calls that users, applications, and/or operating systems submit to the computer file system. If the system monitor 204 determines that a file pathname specifies or corresponds to a target which should be “recovered” (a recovery target), then the system call may be handled by a recovery pre-processing module 206. If the system monitor 204 determines that the file pathname specifies or corresponds to a protected target, the system call may be handled by a protection processing module 212. If the system monitor 204 determines that a system call requires a “file search” of a recovery target, the system call may be handled by recovery main processing module 208. After a computer has been rebooted, a recovery post-processing module 210 may return the recovery targets and protected targets to their original form.

The recovery pre-processing module 206 may perform pre-processing. The technique of the invention is applicable to various file systems. One exemplifying file system uses a file allocation table (FAT). In this case, an operating system stores a file across clusters of a hard disk for subsequent retrieval and stores an entry into the FAT to indicate the clusters in which the file is stored. In one embodiment, the FAT entry can be 16-bits long for DOS and pre-1995 Windows® operating systems, in which case the system can be referred to as a FAT16 file system. The FAT entry can be 32-bits long for Windows® 95, in which case the system can be referred to as a FAT32 file system. Another exemplifying file system is a Windows® NT® file system (NTFS). NTFS stores the location of files in a Master File Table (MFT).

Continuing with the recovery pre-processing module 206, for some targets to be recovered or protected (e.g., C:\WINDOWS\SYSTEM.INI), the recovery pre-processing module 206 may read the table entry (e.g., a root directory entry for a FAT16 or FAT32 file system or a MFT entry for a NTFS file system) matching the target file stored in original system contents 226. Then, the recovery pre-processing module 206 may mark the input and output commands for the relevant target for interception. Next, the recovery pre-processing module 206 may create a copy of the target file and store the target in safety zone information 228.

The recovery main processing module 208 may prevent users from modifying or changing targets by making the safety zone invisible to the users. In one embodiment, the recovery main processing module 208 may determine whether to display the files requested by users or applications according to the settings made by recovery preprocessing module 206. For example, if a user's system call is “file search” of a recovery target that has been marked, then the recovery main processing module 208 may display a search result to the user (e.g., through the user interface 216), which indicates that no such recovery target file was found. But the original recovery target may indeed exist within the computer.

The recovery post-processing module 210 may return targets which have been modified to their original form. In one embodiment, recovery pre-processing module 206 renames and stores original versions of the targets so that the targets can be recovered, for example, by simply renaming the stored original versions to their original names during recovery post-processing. For example, the recovery post processing module 210 may rename the file C:\WINDOWS\SYSTEM_MODIFY.PROTECT in safety zone information 228 to C:\WINDOWS\SYSTEM.INI.

If the system monitor 204 determines that users and/or applications have issued requests or commands that could affect targets which are protected by the safety zone setting processing module 222, the protection processing module 212 may prevent users and/or applications from accessing targets at the source.

In one embodiment, an error handler 214 may handle errors for one or more of the system analyzer 202, the user interface 216, the safety zone setting processing module 222, the system monitor 204, the recovery pre-processing module 206, the recovery main processing module 208, the recovery post-processing module 210, and the protection processor.

In one embodiment, the functionality of safety zone setting module 222, system analyzer 202, system monitor 204, recovery pre-processing module 206, recovery main processing module 208, recovery post-processing module 210, protection processing module 212, and error handler 214 can be provided, implemented, or supported by any one or more suitable processing devices, such as, for example, microprocessor, microcontroller, etc., in a client computer or a server computer.

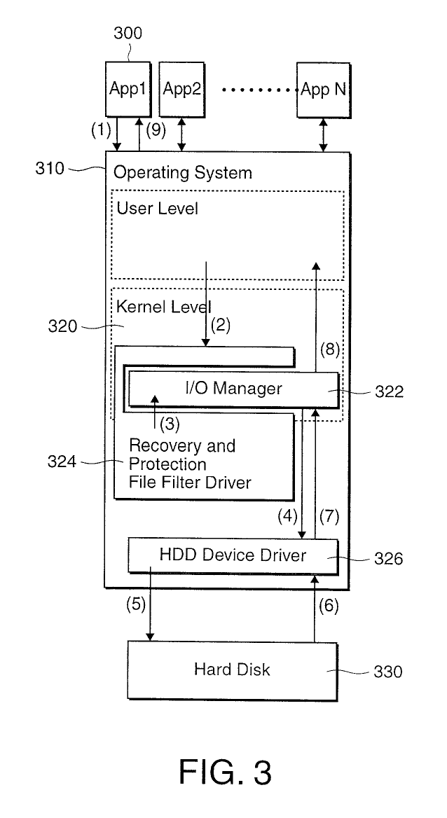

FIG. 3 illustrates an interaction of the recovery and protection system 110 with other computer elements according to an embodiment of the present invention. Initially, an application 300 may make a system call to the underlying operating system 310. The system call may be for creation, deletion, modification, or renaming of a file, directory, registry, or the like.

A system call can be, for example, an input/output (I/O) request message that attempts to access data in the file system.

The operating system may be, for example, Windows® 95, Windows® 98, or Windows® ME. The operating system may include a kernel level 320. The kernel level 320 may include an input/output (I/O) manager 322 and some portion, recovery and protection file filter driver 324. The recovery and protection file filter driven 324 may implement all or a portion of the functionality of the recovery and protection system 110 as a driver. A hard disk drive (HDD) device driver 326 may also be provided.

The operating system 310 may forward the system call from an application program 300 to the kernel level 320. The recovery and protection file filter driver 324 may intercept and hook the system calls. Hook refers to changing a path between a source and a destination. That is, the recovery and protection file filter driver 324 is inserted on the kernel level 320, and then the recovery and protection file filter driver 324 monitors system calls from application program 300 and may modify any system call. Additionally, the recovery and protection file filter driver 324 may further suspend the processing or execution of the system calls. The recovery and protection file filter driver 324 may analyze the system call that was being transferred to the I/O manager 322 prior to interception. The recovery and protection file filter driver 324 may perform preprocessing of the file specified by the system call for protection or recovery. Then, the recovery and protection file filter driver 324 either forwards the original system call to the I/O manager 322 or discards the system call so that it is not further processed.

When the I/O manager 322 receives the system call, the I/O manager 322 may forward the message to the HDD device driver 326. The HDD device driver may access a hard disk 330 based on the system call. The hard disk 330 may include a hard disk controller that returns a result to the HDD device driver 326. In one embodiment, the HDD device driver 326 returns the result to the I/O manager 322, which returns the result to the application program 300.

Here is a more detailed description of “invisible file technology” with reference to FIG. 3. When a user performs a modification on, for example, a file, the recovery and protection file filter driver 324 intercepts a system call going into the I/O Manager 322. If the modification is to be performed on a file in the open zone, normal (i.e., default) processing is executed. If the modification is to be performed on a file in the safety zone, a different process is performed.

If the file to be modified is in the safety zone and the modification is deletion, then the recovery and protection file filter driver 324 commands the HDD device driver 326 to mark the original files. If the file to be modified is in the safety zone and the modification renames a file or changes the content of a file, then the recovery and protection file filter driver 324 commands the HDD device driver 326 to mark the original file, produce a copy of the original file, perform the modification on the copy of the file, and, additionally, mark the modified file (i.e., the copy of the original file being modified). After this process, HDD device driver 326 reports back to the I/O Manager 322. Then the recovery and protection file filter driver 324 again intercepts this message from the HDD device driver 326 and reports back to I/O Manager 322 as if the modification (e.g., deletion, rename, or content modification) has been done.

After each modification, the visible information that is delivered to a user needs to be modified as well. For example, if a user deletes a certain file, it should not appear in the user interface displayed to a user. Therefore, a refresh is performed after each modification. With this refresh, a “find file” system call is passed to the recovery and protection file filter driver 324. Then the recovery and protection file filter driver 324 does not allow display of marked original files. The recovery and protection file filter driver 324 only displays marked modified files, without displaying the marking. Therefore, a deleted file is not visible and modified files are displayed in modified form. The same process occurs when a user searches for certain file. Also, on every reboot, marked modified files are deleted, and marked original files are restored to their original form.

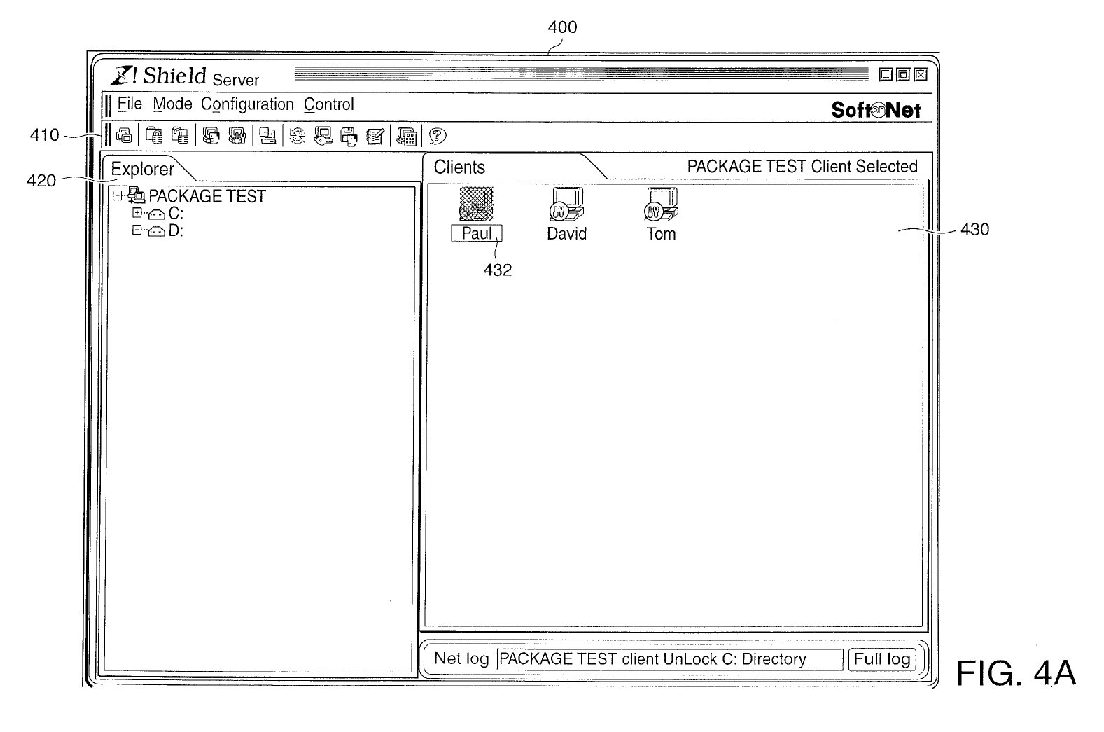

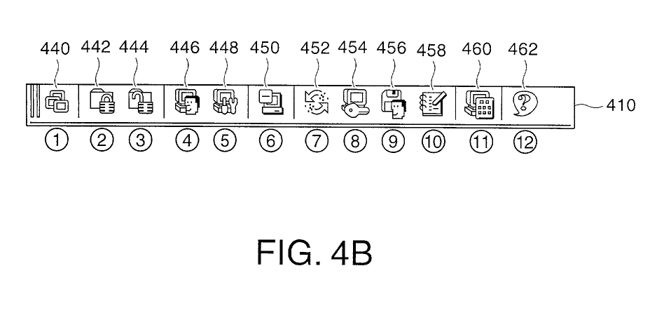

FIG. 4A illustrates a window 400 for a user interface 216 that may be presented on a server computer according to an embodiment of the present invention. In one embodiment, the window 400 can be generated or presented by a server version 220 of user interface 216. The window 400 may include an icon menu bar 410, an explorer window 420, and a client's window 430. The client's window 430 may display icons for each of the clients connected to the server on which window 400 is displayed. When an icon representing a client, such as Paul 432, is selected, the explorer window 420 may list the drives that are included on the client Paul 432. In other embodiments, other user interfaces may be used.

FIG. 4B illustrates the icon menu bar 410 according to an embodiment of the present invention. In alternative embodiments, the menu items may be made available in other forms, for example, in a drop down list or with names in a menu bar, rather than with icons in a menu bar. In one embodiment, a Select All Clients icon 440 allows an administrator to select all clients listed in the client's window 430. A Lock icon 442 allows an administrator to configure, establish or set a recovery area or safety zone, for example, by adding drives or files presented in explorer window 420. An Unlock icon 444 allows an administrator to release drives or files from the safety zone. A User Mode icon 446 allows for a switch to user mode for a client selected in the client's window 430. An Administrator Mode icon 448 allows for a switch to an administrator mode for a client selected in the client's window 430. In one embodiment, when a client is in administrator mode, a user cannot use the computer; only an administrator can use the computer.

A Client Remove icon 450 allows an administrator to remove a client from the client's window 462. A Recovery Now icon 452 recovers a client. In one embodiment, the client is rebooted and processed by the recovery post-processing module 210. A Password icon 454 changes an administrator's password. A User Data Area icon 456 sets a user data area or open zone. A Scheduling icon 458 sets the schedule for recovery. The recovery may occur on rebooting of a computer or periodically (e.g., weekly or daily). A Remote Control icon 460 enables an administrator to remotely control a client selected in the client's window 430. A Help icon 462 provides assistance with use of the recovery and protection system 110. In other embodiments, other icon menu bars may be used that include fewer or more menus with different functions than those described herein.

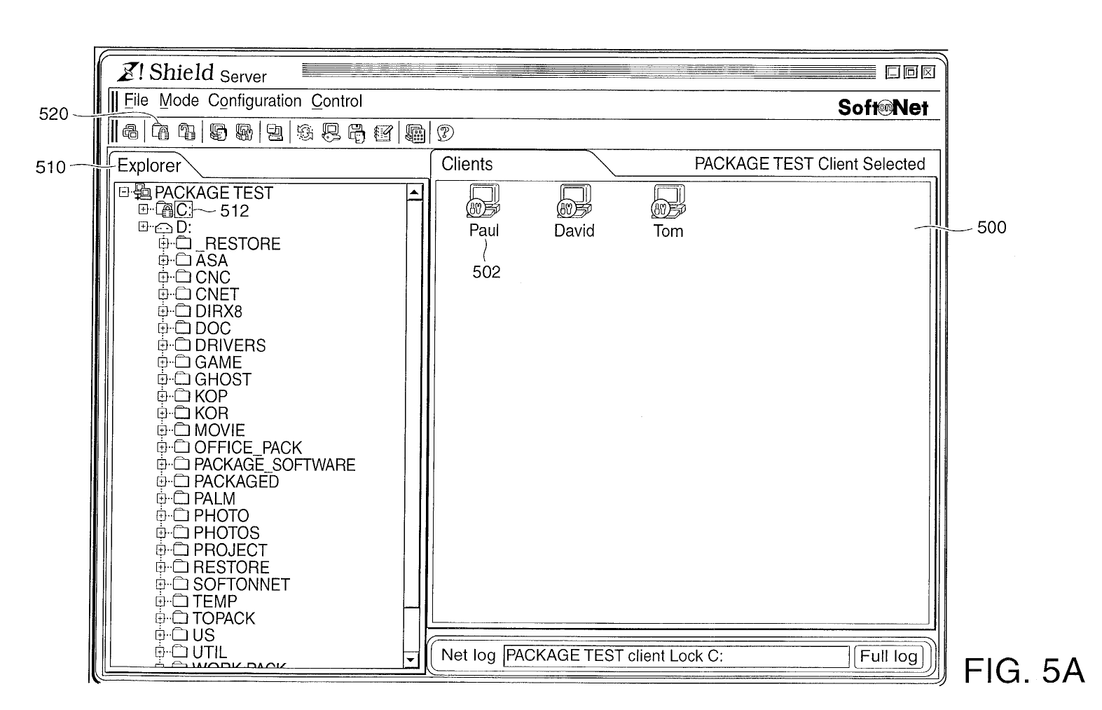

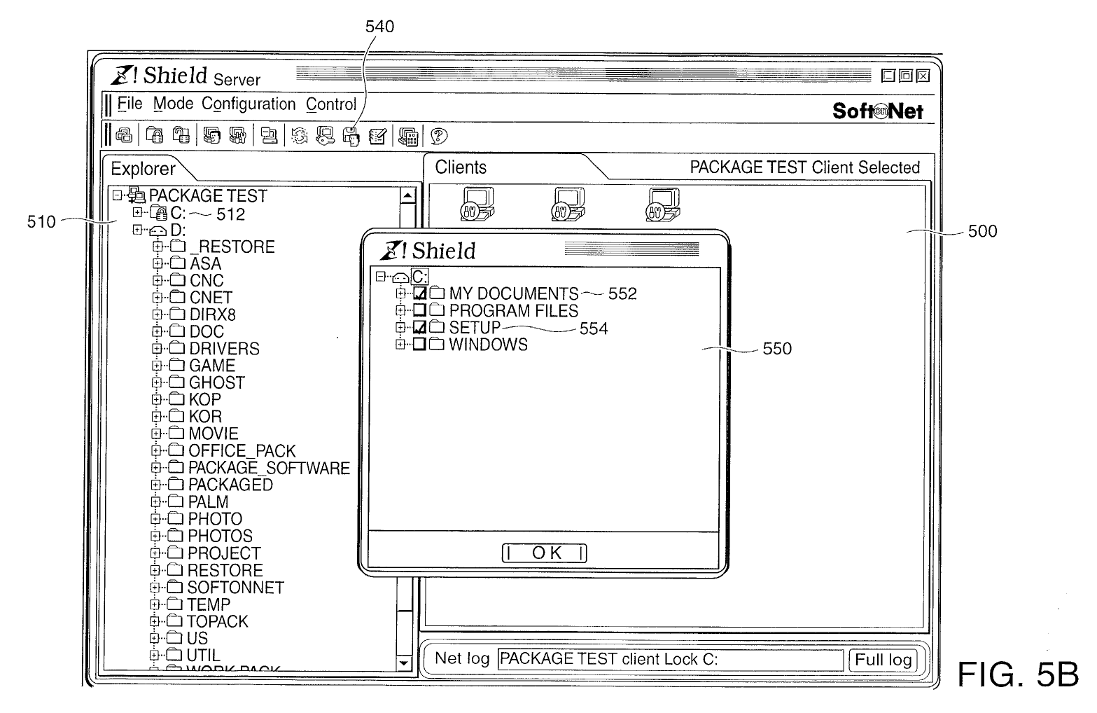

FIGS. 5A and 5B illustrate windows for user interfaces that may be presented to an administrator for setting safety and open zones according to an embodiment of the present invention. In particular, an administrator may select a client, such as Paul 502, in client's window 500. Then, explorer window 510 lists the drives and files on client Paul 502. In this example, an administrator has selected the C drive 512 in the explorer window 510 and selected the Lock icon 520. Therefore, the C drive 512 is locked. A lock graphic may be illustrated on the C drive 512 to indicate that it has been locked. In this example, the C drive is now considered a safety zone. In other embodiments, other user interfaces may be used.

FIG. 5B illustrates how an administrator sets an open zone within a safety zone. In particular, the administrator may select a drive, such as the C drive 512. Then, the administrator may select the User Data Area icon 540. In this manner, an administrator can change a locked drive or folder's subdirectory to be unlocked. A user may create, delete, edit, or rename files in the open zone, but the open zone is not recovered. In response to selection of the User Data Area icon 540, the user interface 216 displays a setting window 550, which lists the contents of the selected C drive 512. An administrator may enter a mark in a box next to the items that are to be in the open zone. In this example, the My Documents folder 552 and the Setup folder 554 have been selected to be in the open zone. In other embodiments, other user interfaces may be used. For example, in other embodiments, the administrator may be able to designate a selection in another manner, for example, by selecting a listed item.

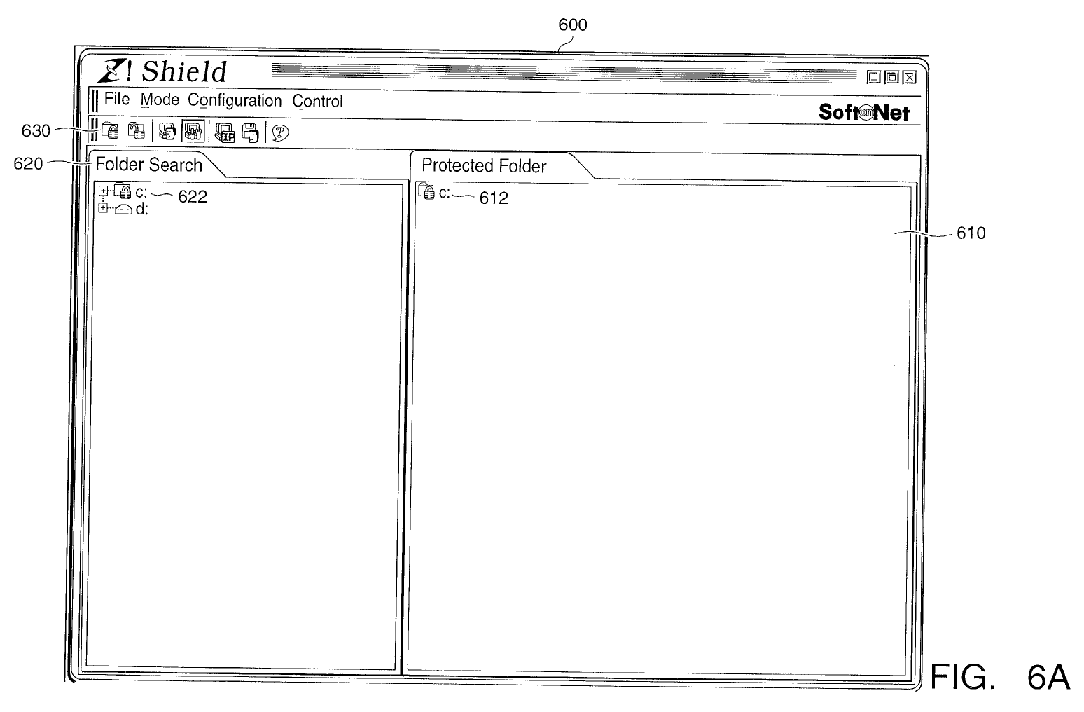

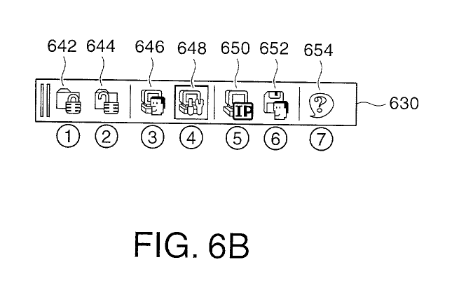

FIG. 6A illustrates a window 600 for a user interface 216 that may be presented on a client computer according to an embodiment of the present invention. In one embodiment, window 600 can be operated or presented by a client version 218 of user interface 216. The client version 218 may enable an administrator to set safety and open zones at a client computer, whether or not connected to the server computer. In one embodiment, when a client computer is connected to the server computer, the client version 218 may not be available at the client computer, requiring an administrator to use a server version at a server computer. In one embodiment, the client version 218 may allow an administrator to set safety and open zones, but may not allow a password to be changed or the recovery schedule to be modified. The window 600 may include a protected folder window 610, a folder search window 620, and an icon menu bar 630. The protected folder window 610 may display the items that have been selected for inclusion in the safety zone, which, in this example, is the C drive 612. The folder search window 620 may list the drives, folders, files, registers and the like for the client. The lock graphic next to a folder indicates that it is in the safety zone (e.g., the C drive 622). In other embodiments, other user interfaces may be used.

FIG. 6B illustrates an icon menu bar 630 according to an embodiment of the present invention. The icon menu bar 630 may include a subset of the icons available on the icon menu bar 410 (FIG. 4B) and one new icon. The subset may include the Lock icon 642, the Unlock icon 644, the User mode icon 646, the Administrator mode icon 648, the Password icon 652, and the Help icon 654. An icon that is not available with a server version is a Change Server icon 650, which allows an administrator to change the server to which the client is connected.

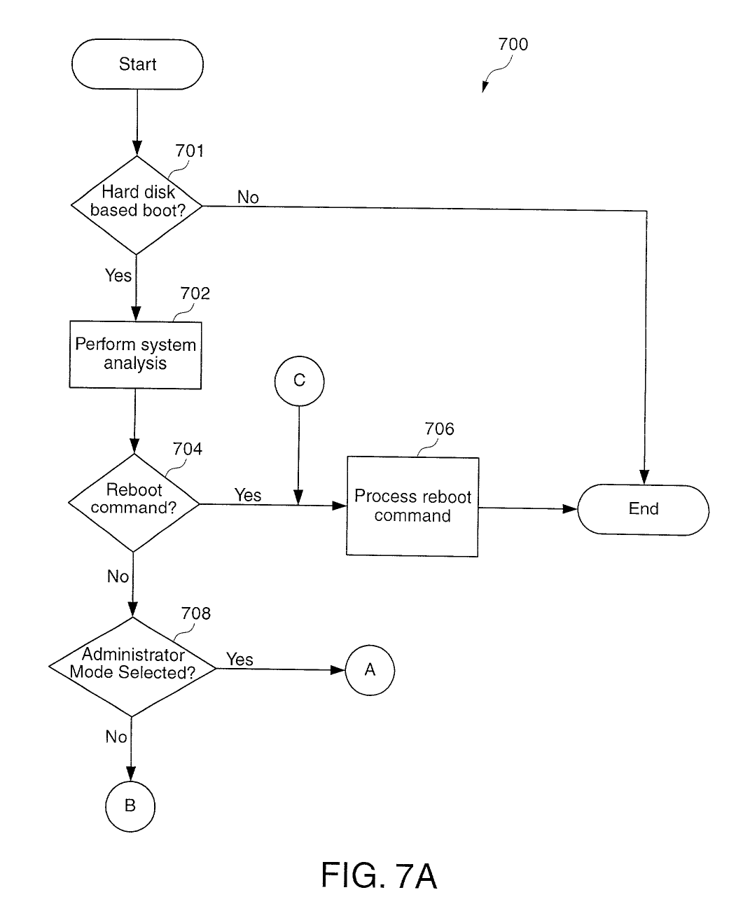

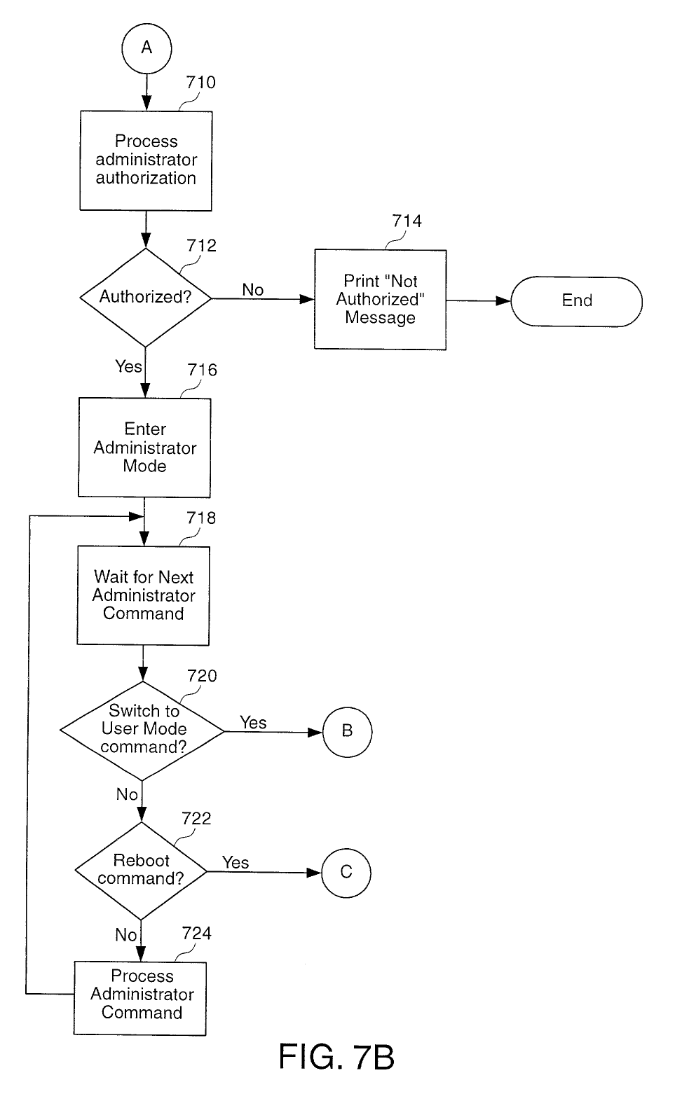

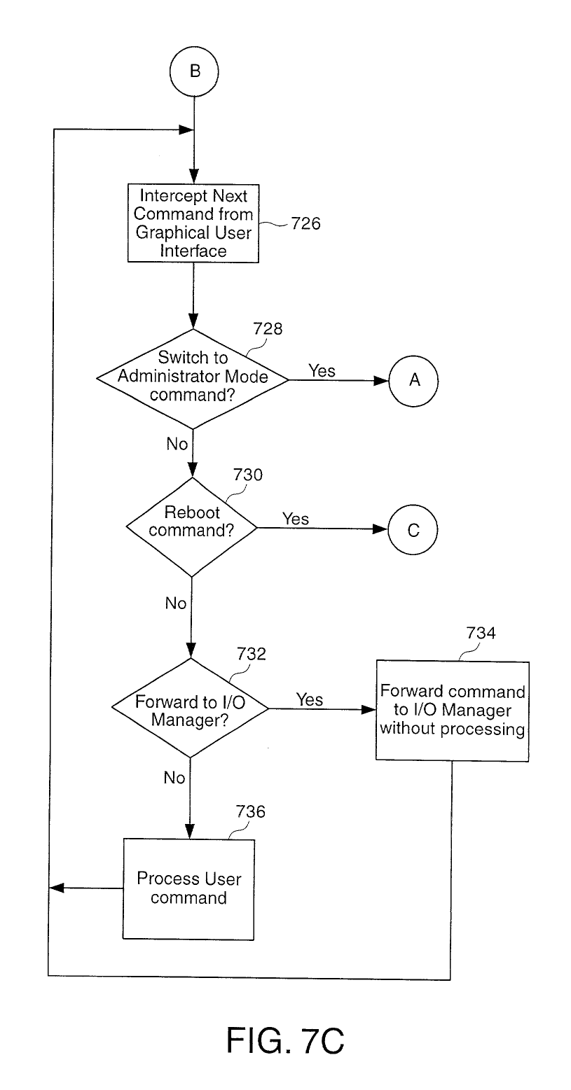

FIGS. 7A-7C illustrate a flowchart of a method 700 for recovery and protection of (i.e., shielding of) files, directories, drives, registers, and the like, according to an embodiment of the present invention. At block 701, the system analyzer 202 of recovery and protection system 110 determines whether there is a hard disk based boot. In one embodiment, the system analyzer 202 does not allow booting with devices other than a hard disk to avoid damage caused by abnormal booting, for example, using a floppy diskette or CD-ROM. If there is a hard disk based boot, method 700 continues at block 702; otherwise, method 700 ends.

At block 702, the system analyzer 202 performs system analysis by analyzing a file system of a user's computer. The system analyzer 202 inspects the original structure of the computer file system, including its composition, information system, and normal status. Then, the system analyzer 202 stores the results (i.e., pathnames) in original system contents 226.

At block 704, the recovery and protection system 110 determines whether a reboot command has been received. If so, method 700 continues at block 706. Otherwise, method 700 continues at block 708. A reboot command may be received from a user, from the operating system due to an error condition, or may be a scheduled reboot. At block 706, the recovery and protection system 110 processes the reboot command, after which method 700 ends.

At block 708, the recovery and protection system 110 determines whether an administrator mode is selected (i.e., whether an individual is accessing the system via user interface 216, as an administrator or an ordinary user). Administrator mode may be selected by selecting Administrator Mode icon 448 (FIG. 4A). If administrator mode is selected, method 700 continues at block 710; otherwise, method 700 continues at block 726.

At block 710, the recovery and protection system 110 processes administrator authentication, for example, by requesting that the individual enter a password. At block 712, the recovery and protection system 110 determines whether the individual is authorized. If so, method 700 continues at block 716 where the computer enters administrator mode. Otherwise, method 700 continues at block 714, in which case a message is displayed on the user interface 216 to indicate that the individual is not authorized, after which method 700 ends. In administrator mode, information about the safety zone is retrieved from safety zone information 228, and the user interface displays information for an administrator (e.g., see FIGS. 4A and 5A).

Once authorized, the individual is known to be an administrator. An administrator selects one or more targets to protect among the following: the file system, drive, directory, file, and/or registry, which could be undesirably damaged by the administrator or other users. At block 718, the recovery and protection system 110 waits for the next administrator command. At block 720, the recovery and protection system 110 determines whether it has received a switch to user mode command. If so, method 700 continues at block 726; otherwise method 700 continues at block 722. At block 722, recovery and protection system 110 determines whether it has received a reboot command. If so, method 700 continues at block 706; otherwise, method 700 continues at block 724 where the administrator command (i.e., a command from an administrator) is processed. Then, processing returns to block 718, and the recovery and protection system 110 waits for another administrator command.

When an individual has selected user mode (e.g., by selecting User Mode icon 446 in FIG. 4A), method 700 continues at block 726. At block 726, the recovery and protection system 110 intercepts the next command from the user interface. At block 728, the recovery and protection system 110 determines whether it has received a switch to administrator mode command. If so, method 700 continues at block 710; otherwise method 700 continues at block 730. At block 730, the recovery and protection system 110 determines whether it has received a reboot command. If so, method 700 continues at block 706; otherwise, method 700 continues at block 732.

At block 732, the recovery and protection system 110 determines whether to forward the command to the I/O manager 322 without processing. If so, method 700 continues at block 734 where the command is forwarded to the I/O manager 322. Otherwise, the recovery and protection system 110 processes the user command at block 736. Thereafter, method 700 returns to block 726.

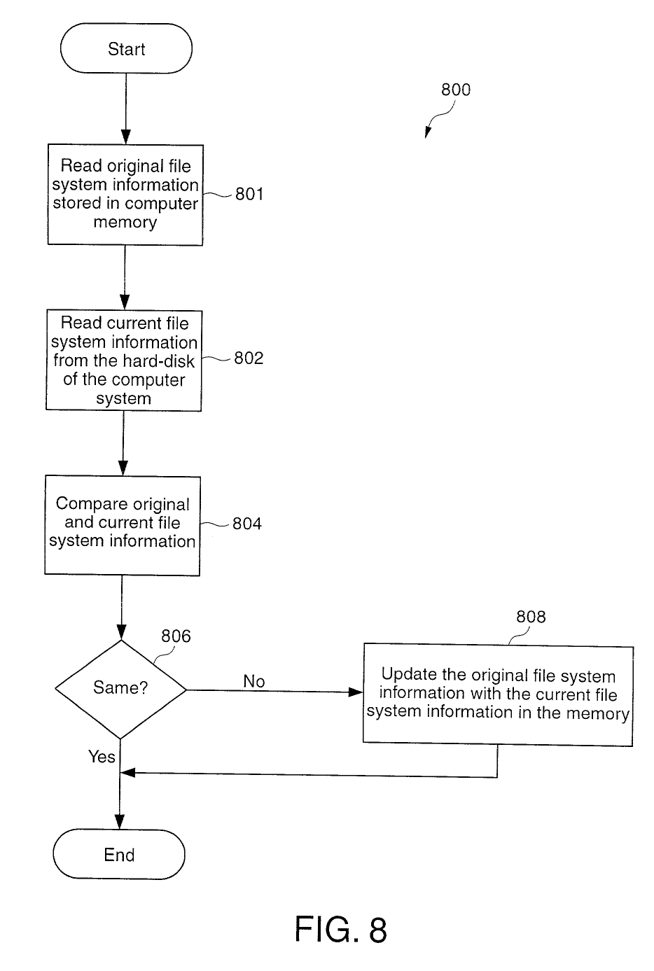

FIG. 8 illustrates a flow chart of a method 800 for performing system analysis, according to an embodiment of the present invention. In one embodiment, method 800 may correspond to block 702 of the method 700. The original information of the file system used during normal operation of the computer file system may be analyzed by inspecting the computer operating system and file structure. Generally, existing file system information stored in data storage 224 can be updated with current file system information after a comparison of those two.

At block 801, the system analyzer 202 of recovery and protection system 110 reads the original file system information stored in original system contents 226. At block 802, the system analyzer 202 reads current file system information from the hard disk of the computer system. At block 804, the system analyzer 202 compares the original and current file system information. At block 806, the system analyzer 202 determines whether they are the same. If so, method 800 ends; otherwise, method 800 continues at block 808. At block 808, the system analyzer 202 updates the original file system information with the current file system information. Method 800 then ends.

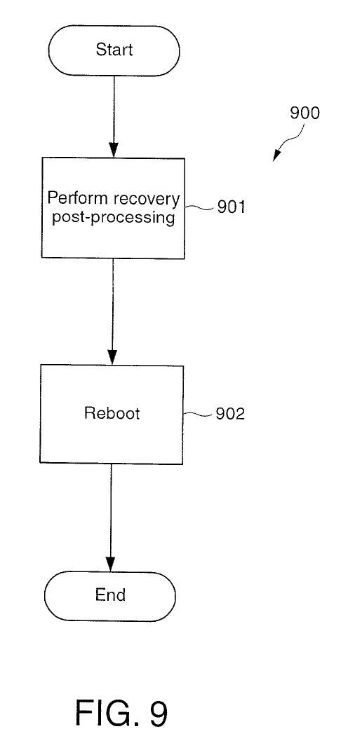

FIG. 9 illustrates a flow chart of a method 900 for processing a reboot command, according to an embodiment of the present invention. In one embodiment, method 900 may correspond to block 706 of the method 700. The reboot command may be requested by a user or by the operating system due to an operating system error or may be scheduled to occur periodically. At block 901, the recovery and protection system 110 performs recovery post-processing, which returns or recovers the user's computer to its initial state. At block 902, the computer system reboots. In one embodiment, recovery post-processing may occur upon reboot of a computer. Method 900 then ends.

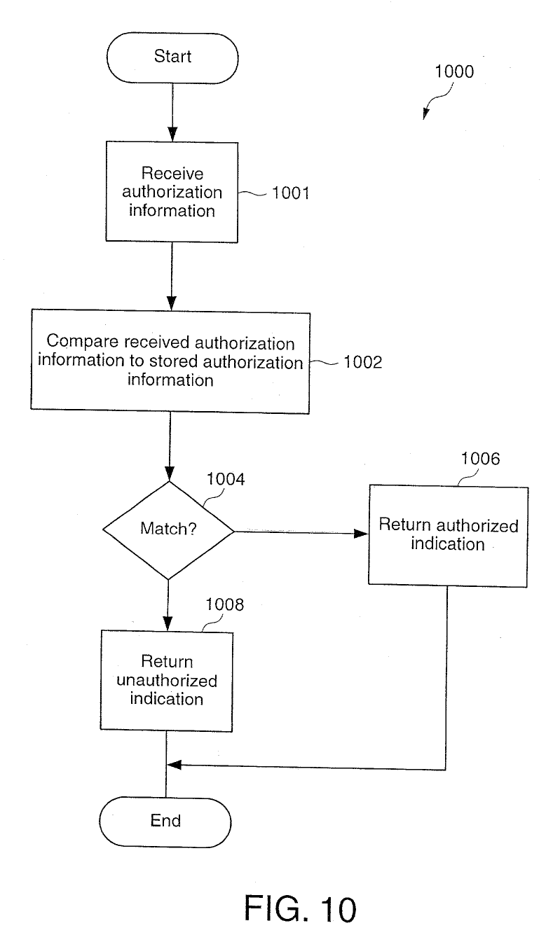

FIG. 10 illustrates a flow chart of a method 1000 for processing administrator authorization, according to an embodiment of the present invention. In one embodiment, method 1000 corresponds to block 710 of the method 700. The recovery and protection system 110 requests authorization information, such as a password (or other authenticating information) from the individual who selected administrator mode via the user interface 216. At block 1001, the recovery and protection system 110 receives authorization information. The correct authorization information is stored in data storage 224. At block 1002, the recovery and protection system 110 compares the received authorization information to the stored authorization information. At block 1004, the recovery and protection system 110 determines whether there is a match. If there is a match, the administrator is authenticated and an authorized indicator is returned (block 1006); otherwise, an unauthorized indicator is returned (block 1008). Method 1000 then ends.

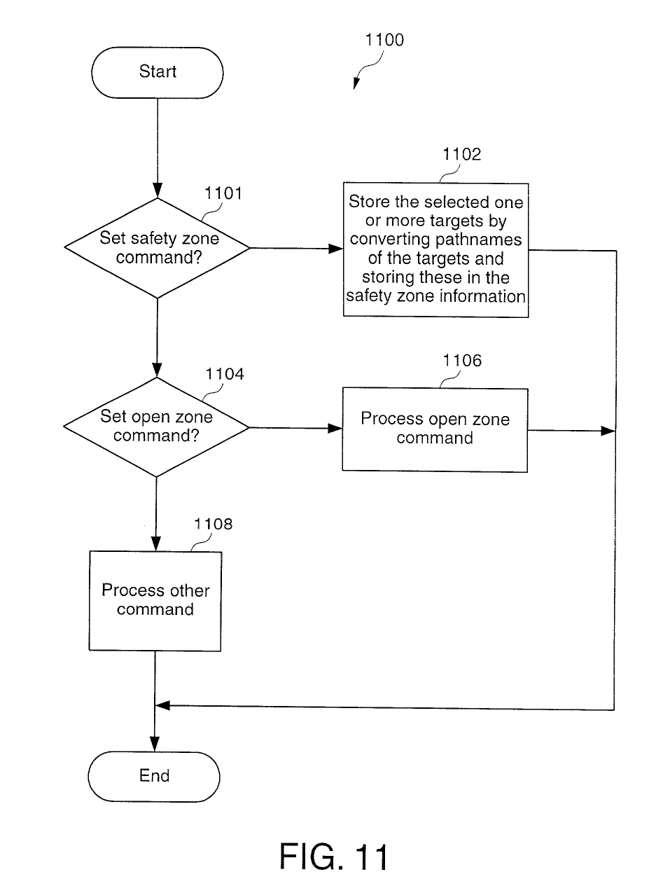

FIG. 11 illustrates a flow chart of a method 1100 for processing an administrator command, according to an embodiment of the present invention. In one embodiment, method 1000 corresponds to block 724 of method 700. At block 1101, the recovery and protection system 110 determines whether it has received a set safety zone command. If so, method 1100 continues at block 1102; otherwise, method 1100 continues at block 1104.

At block 1102, the safety zone setting processing module 222 converts the pathname of each target selected for recovery and protection into strings and stores the converted names in safety zone information 228. At block 1104, the recovery and protection system 110 determines whether it has received a set open zone command. If so, method 1100 continues at block 1106; otherwise method 1100 continues at block 1108. At block 1106, the recovery and protection system 110 processes the open zone command by storing information indicating that the selected targets are in an open zone. Any targets in the open zone are not protected by recovery and protection system 110, and thus can be modified, deleted, or otherwise damaged by a user. At block 1108, the recovery and protection system 110 processes a command that is not related to setting the safety or open zones. Method 1000 ends.

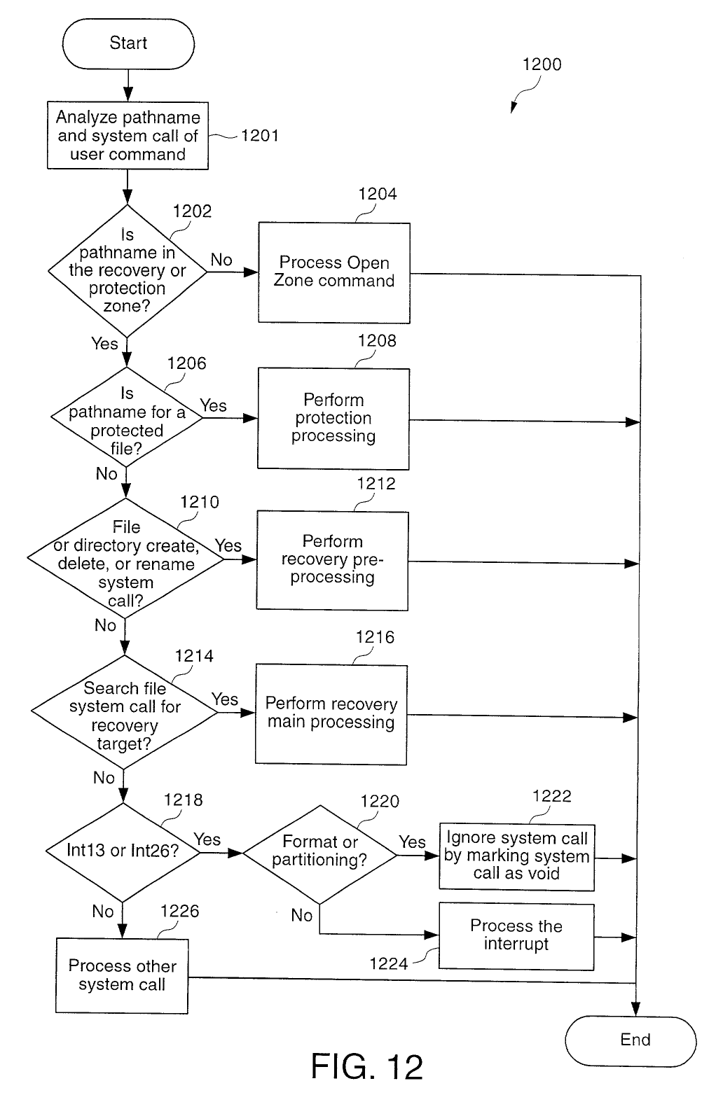

FIG. 12 illustrates a flow chart of a method 1200 for processing a user command, according to an embodiment of the present invention. In one embodiment, method 1200 corresponds to block 736 of method 700. If the user is not an administrator, then at block 1201 the system monitor 204 analyzes the file pathname and system call requested by users and/or applications. At block 1202, the system monitor 204 determines whether the pathname is in the recovery or protected zone (i.e., the safety zone). To accomplish this, in one embodiment, the system monitor 204 reads the safety zone stored in safety zone information 228 and determines whether the file pathname is a recovery or protected target. If so, method 1200 continues at block 1206; otherwise, method 1200 continues at block 1204. At block 1204, the recovery and protection system 110 processes the open zone command, for example, allowing the open zone command to be executed in its normal fashion. Method 1200 ends.

At block 1206, the system monitor 204 determines whether the file pathname is for a protected file. If so, method 1200 continues at block 1208 and protection processing is performed. Protection processing prevents the target from being accessed by users and applications. Otherwise, method 1200 continues at block 1210.

At block 1210, the system monitor 204 determines whether it has received a file or directory create, delete, or rename system call. If so, method 1200 continues at block 1212 where recovery pre-processing is performed. Method 1200 ends. Otherwise, method 1200 continues at block 1214.

At block 1214, the system monitor 204 determines whether it has received a “search file” (sometimes referred to as “find file”) system call for a recovery target. If so, method 1200 continues at block 1216 where recovery main processing is performed, after which method 1200 ends. Otherwise, method 1200 continues at block 1218.

At block 1218, the system monitor 204 determines whether it has received an interrupt call, which can be, for example, an interrupt 13 (Int13) or an interrupt 26 (Int26). If so, method 1200 continues at block 1220; otherwise method 1200 continues at block 1226 to process another system call, after which method 1200 ends. At block 1220, the system monitor 204 determines whether the system call is format or partition. For example, the system call may be FDISK, which is a utility for formatting and partitioning a disk. If the system call is related to a direct access of the hard disk, the system call is invalidated to protect partition information on the file system and to protect the system master boot record. Thus, if the system call is format or partition, method 1200 continues at block 1222, where the system call is ignored by marking the system call as void. In one embodiment, ignoring the system call means that it is ineffective in the system itself, but nonetheless, recovery and protection system 110 may present an interface to the user which makes it appear that the command has been performed. If the system call is not format or partition, method 1200 continues at block 1224, and the interrupt is processed, for example, by allowing its normal execution.

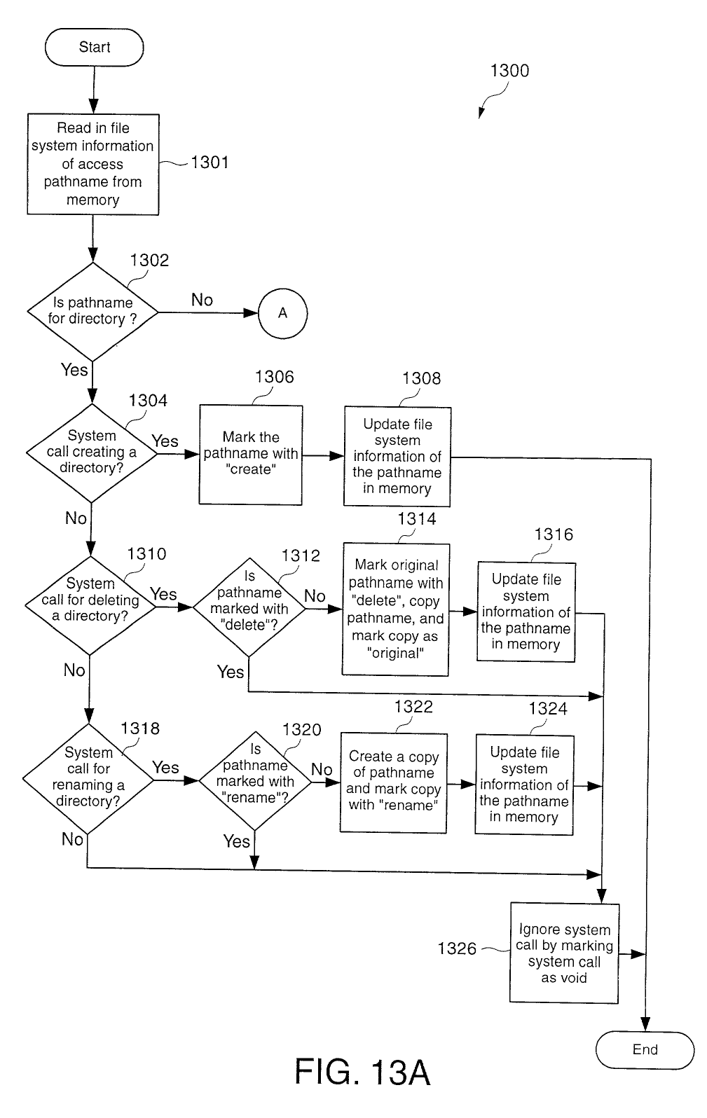

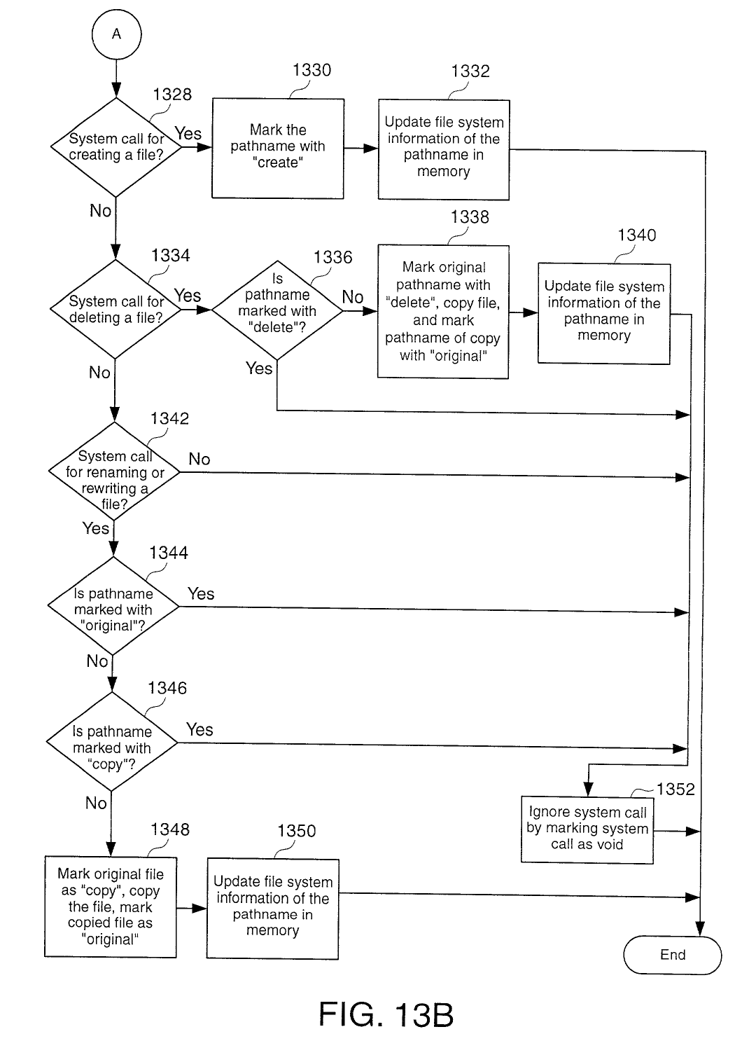

FIGS. 13A and 13B illustrate a flow chart of a method 1300 for performing recovery pre-processing, according to an embodiment of the present invention. In one embodiment, method 1300 corresponds to block 1212 of method 1200. The recovery pre-processing module 206 may perform processing for making a copy of each target to be recovered, marking the original file, and deciding whether to use invisible file technology at the main processing module 208. Basically, when a user performs search of certain files or directories on, for example, a Windows® Internet Explorer browser, the “invisible file technology” of the present invention decides whether or not to display the results (e.g., the target file or directory on which a user performed search) of the search. For example, if a user deletes a file called “C:\A.TXT,” the recovery and protection system 110 changes and marks the file “C:\A.TXT” to “C:\A.TXT_DELETE.PROTECT” at the pre-processing module 206. Then, while monitoring system calls from applications at the main-processing module 208, the marked file or directory is hidden continuously on each search performed in the Windows) Internet Explorer browser by the recovery and protection system 110. Therefore, it seems as if the mentioned file, “C:\A.TXT,” has been deleted, but it is actually hidden and exists, for example, in the local disk of the computer.

At block 1301, the recovery and protection system 110 reads in file system information of a file pathname from memory (for example, from original system contents 226) after receiving a file or directory create, delete, or rename system call. At block 1302, the recovery and protection system 110 determines whether the file pathname is for a directory. If so, method 1300 continues at block 1304; otherwise, method 1300 continues at block 1328.

At block 1304, the recovery and protection system 110 determines whether it has received a system call for a creating directory. If so, method 1300 continues at block 1306; otherwise, method 1300 continues at block 1310. At block 1306 the recovery and protection system 110 marks the pathname with “create.” At block 1308, the recovery and protection system 110 updates the file system information of the pathname in memory, after which method 1300 ends.

At block 1310, the recovery and protection system 110 determines whether it has received a system call for a deleting directory. If so, method 1300 continues at block 1312; otherwise, method 1300 continues at block 1318. At block 1312, the recovery and protection system 110 determines whether the pathname is already marked with “delete.” If so, the system call is ignored by marking the system call as void at block 1326, after which method 1300 ends. Otherwise, method 1300 continues at block 1314. That is, when the pathname is not marked with “delete,” the access file pathname (i.e., the pathname of the file to be accessed) is changed. In particular, at block 1314, the recovery and protection system 110 marks the original pathname with “delete,” copies the pathname, and marks the copy as “original.” In other words, the copy is marked with “original,” and the previous name of the target is marked with “delete.” At block 1316, the recovery and protection system 110 updates file system information of the pathname in memory. Method 1300 moves to block 1326.

At block 1318, the recovery and protection system 110 determines whether it has received a system call for a renaming directory. If so, method 1300 continues at block 1320; otherwise, the system call is ignored at block 1326. At block 1320, the recovery and protection system 110 determines whether the pathname is marked with “rename.” If so, the system call is ignored; otherwise, method 1300 continues at block 1322. In other words, if the system call is asking for the directory to be renamed again (for example, the directory was already renamed by an administrator), the system call is disregarded. On the other hand, when the access file pathname is not marked with “rename,” the access file pathname is converted. In particular, at block 1322, the recovery and protection system 110 creates a copy of the pathname, marks the copy with “rename,” and stores the copy in safety zone information 228. At block 1324, the recovery and protection system 110 updates file system information of the pathname in memory. Then, the system call is ignored by marking the system call as void at block 1326. Consequently, the access file pathname remains unchanged in the system, although recovery and protection system 110 may cause the file pathname to appear as if it has been renamed.

At block 1328, the recovery and protection system 110 determines whether it has received a system call for a creating file. If so, method 1300 continues at block 1330; otherwise, method 1300 continues at block 1334. At block 1330, the recovery and protection system 110 marks the pathname with “create.” At block 1332, the recovery and protection system 110 updates the file system information of the pathname in memory. Method 1300 ends thereafter.

At block 1334, the recovery and protection system 110 determines whether it has received a system call for deleting a file. If so, method 1300 continues at block 1336; otherwise, method 1300 continues at block 1342. At block 1336, the recovery and protection system 110 determines whether the pathname is already marked with “delete.” If so, the system call is ignored by marking the system call as void at block 1352, after which method 1300 ends. Otherwise, method 1300 continues at block 1338. At block 1338, the recovery and protection system 110 marks the original pathname with “delete,” copies the pathname, and marks the copy as “original.” In other words, the copy is marked with “original,” and the previous name of the target is marked with “delete.” At block 1340, the recovery and protection system 110 updates file system information of the pathname in memory. Method 1300 moves to block 1352.

At block 1342, the recovery and protection system 110 determines whether it has received a system call for renaming or rewriting a file. If not, the system call is ignored at block 1352; otherwise, method 1300 continues at block 1344. At block 1344, the recovery and protection system 110 determines whether the pathname is marked with “original” (for example, it was previously deleted). If so, the system call is ignored at block 1352; otherwise, method 1300 continues at block 1346. At block 1346, the recovery and protection system 110 determines whether the pathname is marked with “copy” (for example, it was previously renamed). If so, the system call is ignored at block 1352; otherwise, method 1300 continues at block 1348. At block 1348, the recovery and protection system 110 marks the original file as “copy,” copying the file, and marking the copied file as “original.” At block 1350, the recovery and protection system 110 updates file system information of the pathname in memory. Thereafter, method 1300 ends.

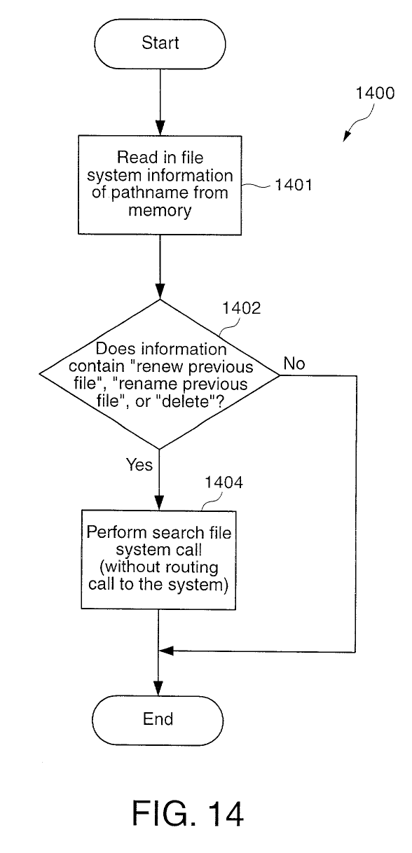

FIG. 14 illustrates a flow chart of a method 1400 for performing recovery main processing, according to an embodiment of the present invention. In one embodiment, method 1400 may correspond to block 1216 of method 1200. The recovery main processing module 208 establishes one or more protection targets based on the result of marking procedures by the pre-processing module 206 and the safety zones set by the administrator. The recovery main processing module 208 makes the target invisible to users and prevents them from modifying or changing the target.

At block 1400, the recovery and protection system 110 reads in file system information of a pathname from memory (e.g., in original system contents 226) after receiving a search file system call. At block 1402, the recovery and protection system 110 determines whether the file system information contains “renew previous file,” “rename previous file” or “delete.” If so, method 1400 continues at block 1404; otherwise, method 1400 ends. In one embodiment, the recovery and protection system 110 voids the system call before ending. At block 1404, the recovery and protection system 110 performs a search file system call (without routing the call to the system). That is, when the invisible file technology is in effect, recovery and protection system 110 recalls the system call within the “find file” system, which means disregarding the “find file” system call by users, but recalling a “find file” system call on the marked target within the system. Thus, it appears to a user that the computer is responding to a find file request.

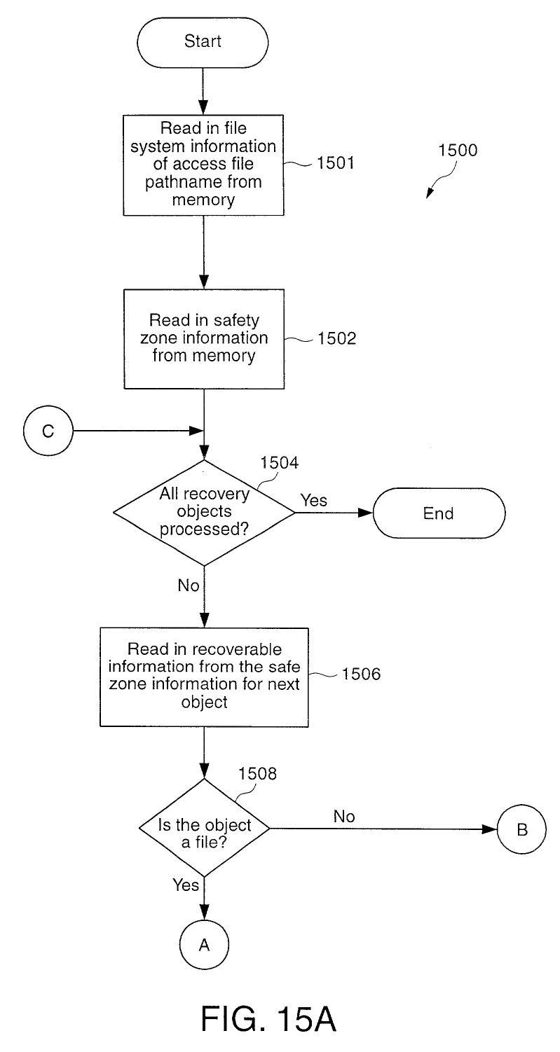

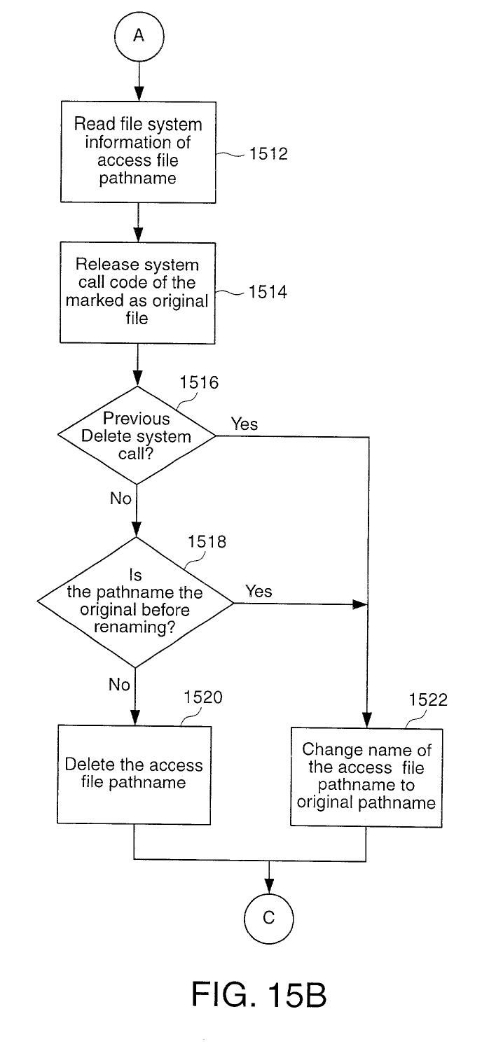

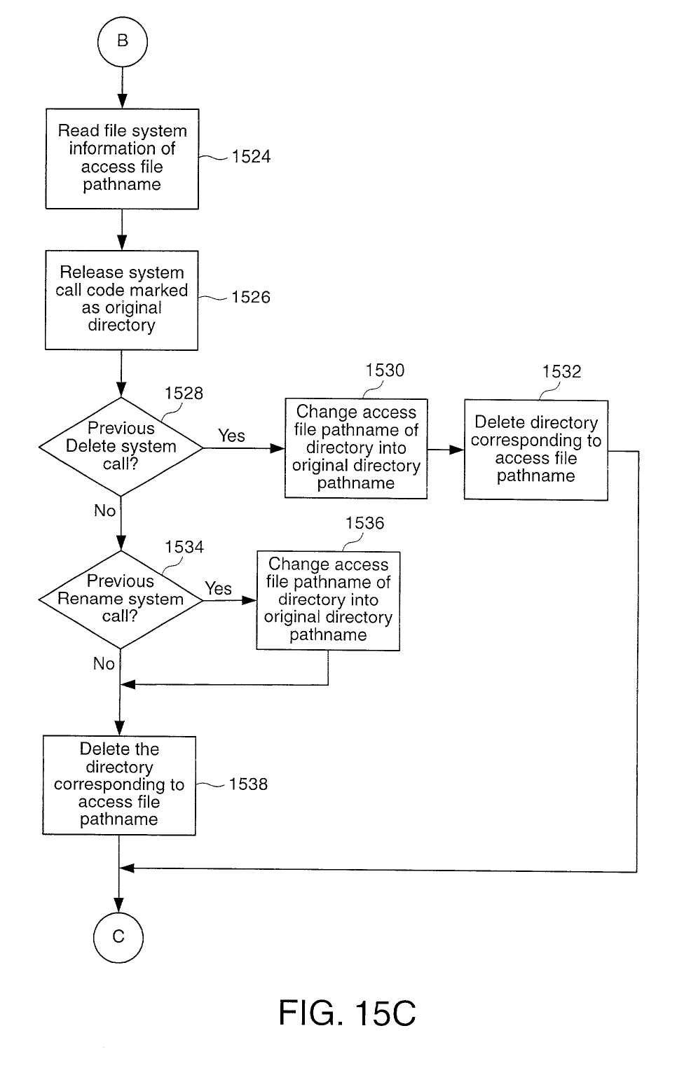

FIGS. 15A-15C illustrate a flow chart of a method 1500 for performing recovery post-processing, according to an embodiment of the present invention. In one embodiment, method 1500 may corresponds to block 900 of method 900. The recovery post-processing module 210 recovers or restores damaged or changed targets by renaming a copy of a file to the name of the original file.

At block 1501, the recovery and protection system 110 reads in file system information of an access file pathname from memory (for example, original system contents 226). At block 1502, the recovery and protection system 110 reads in safety zone information from memory (for example, safety zone information 228). At block 1504, the recovery and protection system 110 determines whether all recovery objects have been processed, for example, by comparing the file system information in original system contents 226 and in safety zone information 228. If so, method 1500 ends; otherwise, method 1500 continues at block 1506.

At block 1506, the recovery and protection system 110 reads in recoverable information from the safety zone information 228 for the next object (starting with the first one that needs to be recovered). At block 1508, the recovery and protection system 110 determines whether the object to be recovered is a file. If so, method 1500 continues at block 1512; otherwise, method 1500 continues at block 1524.

At block 1512, the recovery and protection system 110 reads file system information for the access file pathname (i.e., marked system code for deleted or modified files and directories). At block 1514, the recovery and protection system 110 releases system call code for the file marked original (e.g., so that a pending system call for the file marked original is not processed). At block 1516, the recovery and protection system 110 determines whether the pathname has been previously deleted with a delete system call. If so, method 1500 continues at block 1522, where the recovery and protection system 110 changes the access file pathname to the original pathname, after which method 1500 returns to block 1504. Otherwise, the recovery and protection system 110 determines whether the pathname is the original before renaming at block 1518. If so, method 1500 continues at block 1522; otherwise, method 1500 continues at block 1520 where the recovery and protection system 110 deletes the access file pathname of the file. Method 1500 then returns to block 1504.

At block 1524, the recovery and protection system 110 reads the file system information of the access file pathname. At block 1526, the recovery and protection system 110 releases system call code for the directory marked as original. At block 1528, the recovery and protection system 110 determines whether the pathname had been previously deleted with a delete system call. If so, method 1500 continues at block 1530; otherwise, method 1500 continues at block 1534. At block 1530, the recovery and protection system 110 changes the access file pathname into an original directory pathname (i.e., renaming it). At block 1532, the recovery and protection system 110 deletes the directory corresponding to the access file pathname, after which method 1500 ends. At block 1534, the recovery and protection system 110 determines whether the pathname had been previously renamed with a rename system call. If so, method 1500 continues at block 1536; otherwise, method 1500 continues at block 1538. At block 1536, the recovery and protection system 110 changes the access file pathname into an original directory pathname. At block 1538, the recovery and protection system 110 deletes the directory corresponding to the access file pathname. Method 1500 ends.

With embodiments of the present invention, when a user intentionally or accidentally attempts to damage targets in the safety zone, these targets will appear corrupted to users, but the original information of the targets remains undamaged. Therefore, it is possible to recover or protect the damaged files only (rather than, for example, an entire file system), thus allowing for a swift recovery process compared to conventional techniques. This is true especially when the operating system is damaged. By recovering only the damaged files or directories, instead of resetting and/or reloading an entire file and/or operating system, the recovery and protection system 110 provides better speed and performance.

Although particular embodiments of the present invention have been shown and described, it will be obvious to those skilled in the art that changes or modifications may be made without departing from the present invention in its broader aspects. The appended claims are to encompass within their scope all such changes and modifications that fall within the true scope of the present invention.

What is claimed is:

1. A system for protecting a file system of a computer, comprising:
an interface operable to receive a selection of an item of the file system to be included in a safety zone;
a memory in communication with the interface and operable to store information relating to the item; and
a processor in communication with the memory and operable to intercept a system call which potentially could affect the item in the safety zone, and to process the system call to avoid permanent modification of the item.

2. The system of claim 1, wherein the processor is operable to examine a composition, information structure, and normal status of the file system.

3. The system of claim 1, wherein the processor is operable to cause the computer to only boot from a hard disk drive of the computer.

4. The system of claim 1, wherein the safety zone comprises at least one of a file system, a drive, a directory, a file, or a registry for the computer.

5. The system of claim 1, wherein the interface is operable to present information about the safety zone.

6. The system of claim 1, wherein the processor is operable to present a user of the computer with an impression that the system call was executed even when the system call actually has not been executed.

7. The system of claim 1, wherein the processor is operable to make the item transparent to a user of the computer.

8. A method of protecting and recovering a file system in a computer, comprising the steps of:
storing file system information obtained from examining an operating system and a file system structure in the computer;
setting a safety zone based on selection of a target that is to be protected or recovered, wherein selection is made in response to input by an authenticated administrator;
receiving a system call referencing a file pathname corresponding to the target;
analyzing the system call to determine if the system call affects the target; and
if said system call may affect the target, performing processing to avoid permanent modification of the target.

9. The method of claim 8, wherein performing processing comprises creating a copy of the target.

10. The method of claim 8, wherein performing processing comprises making the target transparent to a user of the computer.

11. The method of claim 8, wherein performing processing comprises making the system call void.

12. The method of claim 8, comprising verifying a booting media for the computer to prevent use of abnormal booting media.

13. The method of claim 12, wherein the abnormal booting media comprises a floppy disk or a CD-ROM drive.

14. The method of claim 8, further comprising examining a composition, information structure, and normal status of the file system.

15. The method of claim 8, wherein the stored file system information comprises original file system information, and further comprising:
comparing the original file system information with current file system information; and
replacing the original file system information with the current file system information if the original file system information and the current file system information are not identical.

16. The method of claim 8, wherein the target comprises at least one of a file system, a drive, a directory, a file, or a registry of the computer.

17. The method of claim 8, wherein the system call is for creating a target and wherein performing processing comprises:
creating the target; and
updating current file system information to show that the target has been created.

18. The method of claim 8, wherein the system call is for deleting a target and wherein performing processing comprises:
when the target has not already been deleted,
copying the target for recovery; and
updating current file system information to show that the target has been deleted.

19. The method of claim 18, further comprising:
when the target has already been deleted, voiding the system call.

20. The method of claim 8, wherein the system call is for renaming a target and wherein performing processing comprises:
when the target has not already been renamed,
copying the target for recovery; and
updating current file system information to show that the target has been renamed.

21. The method of claim 20, wherein the system call is for renaming a target and wherein performing processing comprises:
when the target has already been renamed, voiding the system call.

22. The method of claim 8, wherein the system call comprises searching for a target and further comprising:
searching for the target using the current file system information.

23. The method of claim 22, further comprises:
searching for the target if the target is marked with renew, rename, or delete.

24. The method of claim 8, further comprising:
recovering the target.

25. The method of claim 24, wherein the target is recovered by comparing the stored file system information to current file system information.

26. The method of claim 24, wherein the target is recovered by renaming a stored copy of the target.

27. The method of claim 8, wherein performing processing comprises preventing access to the target.

28. The method of claim 8, wherein the system call is for an interrupt and wherein processing further comprises:
voiding the system call if processing the interrupt would affect partition information of the file system.

29. A method of protecting and recovering a file system of a computer comprising:
receiving a selection of an item to be included in a safety zone;
intercepting a system call which potentially could affect the item in the safety zone; and
performing processing responsive to the system call so that the item is not permanently modified.

30. The method of claim 29, further comprising updating file system information on a data storage device coupled to the computer with file system information from a disk drive coupled to the computer.

31. The method of claim 29, wherein performing processing comprises voiding the system call.

32. The method of claim 31, wherein performing processing comprises providing a user of the computer with an impression that the system call was executed.

33. The method of claim 29, wherein performing processing comprises:
determining that the system call is a find file request; and
if execution of the find file request would access an item in a safety zone,
performing the find file request without accessing the file system.

34. The method of claim 29, wherein performing processing comprises making a copy of the item.

35. The method of claim 29, wherein performing processing comprises making the item transparent to a user of the computer.

36. The method of claim 29, wherein performing processing comprises making the system call void.

37. The method of claim 29, comprising verifying a booting media for the computer to prevent use of abnormal booting media.

38. The method of claim 29, further comprising storing original file system information.

39. The method of claim 38, further comprising:
comparing the stored original file system information with current file system information; and
replacing the original file system information with the current file system information if the original file system information and the current file system information are not identical.

40. The method of claim 29, wherein the item comprises at least one of a file system, a drive, a directory, a file, or a registry of the computer.

41. The method of claim 29, wherein the system call is for creating an item and wherein performing processing comprises:
creating the item; and
updating current file system information to show that the item has been created.

42. The method of claim 29, wherein the system call is for deleting an item and wherein performing processing comprises:
when the item has not already been deleted,
copying the item for recovery; and
updating current file system information to show that the item has been deleted.

43. The method of claim 42, further comprising:
when the item has already been deleted, voiding the system call.

44. The method of claim 29, wherein the system call is for renaming an item and wherein performing processing comprises:
when the item has not already been renamed,
copying the item for recovery; and
updating current file system information to show that the item has been renamed.

45. The method of claim 44, wherein the system call is for renaming an item and wherein performing processing comprises:
when the item has already been renamed, voiding the system call.

46. The method of claim 29, wherein the system call comprises searching for an item and further comprising:
searching for the item using the current file system information.

47. The method of claim 46, further comprises:
searching for the item if the item is marked with renew, rename, or delete.

48. The method of claim 29, wherein performing processing comprises recovering items in the safety zone.

49. The method of claim 48, wherein recovering occurs periodically.

50. The method of claim 48, wherein recovering occurs upon reboot.

51. The method of claim 48, wherein the item is recovered by comparing the stored file system information to current file system information.

52. The method of claim 48, wherein the item is recovered by renaming a stored copy of the item.

53. The method of claim 29, wherein performing processing comprises preventing access to the item.

54. The method of claim 29, wherein the system call is for an interrupt and wherein processing further comprises:
voiding the system call if processing the interrupt would affect partition information of the file system.

55. A method of protecting and recovering a file system of a computer comprising:
receiving a selection of an item to be included in a safety zone from an administrator;
intercepting a system call received from a user which potentially could affect the item in the safety zone; and
performing processing responsive to the system call so that the item is not permanently modified.

56. The method of claim 55, further comprising:
authenticating the administrator.

57. The method of claim 56, further comprising:
receiving authorization information from the administrator; and
comparing the received authorization information to stored authorization information to determine whether to authenticate the administrator.

58. The method of claim 55, wherein the item is a first item, further comprising:
receiving a selection of a second item to be included in an open zone from an administrator.

59. The method of claim 58, wherein the second item may be permanently modified.

60. The method of claim 58, wherein the item is a first item, further comprising:
receiving a selection of a second item to be protected from an administrator.

61. The method of claim 60, further comprising:
restricting user access to the second item.

62. The method of claim 55, wherein the item is stored as an original item, and wherein performing processing comprises:
creating a copy of the original item;
storing the copy for recovery; and
allowing a user to access the original item.

63. The method of claim 55, wherein performing processing comprises making the item transparent to a user of the computer.

64. The method of claim 55, wherein performing processing comprises making the system call void.

65. A computer-readable storage medium storing a computer program executable by one or more computers, the computer program comprising computer instructions for:
receiving a selection of an item to be included in a safety zone;
intercepting a system call which potentially could affect the item in the safety zone; and
performing processing responsive to the system call so that the item is not permanently modified.

66. The computer-readable storage medium method of claim 65, wherein performing processing further comprises instructions for voiding the system call.

67. The computer-readable storage medium method of claim 66, wherein performing processing further comprises providing instructions for providing a user of the computer with an impression that the system call was executed.

68. The computer-readable storage medium method of claim 65, wherein performing processing further comprises instructions for:
determining that the system call is a find file request; and
if execution of the find file request would access an item in a safety zone,
performing the find file request without accessing the file system.

69. The computer-readable storage medium method of claim 65, further comprising instructions for verifying a booting media for the computer to prevent use of abnormal booting media.

70. The computer-readable storage medium method of claim 65, further comprising instructions for:
storing original file system information;
at a later time, comparing the stored original file system information with current file system information; and
replacing the original file system information with the current file system information if the original file system information and the current file system information are not identical.

71. The computer-readable storage medium method of claim 65, wherein the system call is for creating an item and wherein performing processing further comprises instructions for:
creating the item; and
updating current file system information to show that the item has been created.

72. The computer-readable storage medium method of claim 65, wherein the system call is for deleting an item and wherein performing processing further comprises instructions for:
when the item has not already been deleted,
copying the item for recovery; and
updating current file system information to show that the item has been deleted.

73. The computer-readable storage medium method of claim 65, wherein the system call is for renaming an item and wherein performing processing further comprises instructions for:
when the item has not already been renamed,
copying the item for recovery; and
updating current file system information to show that the item has been renamed.

74. The computer-readable storage medium method of claim 65, further comprising instructions for recovering items in the safety zone.

75. The computer-readable storage medium method of claim 74, wherein the item is recovered by renaming a stored copy of the item.

76. The computer-readable storage medium method of claim 65, wherein performing processing further comprises instructions for preventing access to the item.

77. The computer-readable storage medium method of claim 65, wherein the system call is for an interrupt and wherein processing further comprises instructions for:
voiding the system call if processing the interrupt would affect partition information of the file system.
